(19) United States
(12) Patent Application Publication
(10) Pub. No.: US 2005/0140337 A1
(43) Pub. Date: Jun. 30, 2005

(54) Charging apparatus

(76) Inventors: Allwyn Jacob D' Cunha, Samutprakarn (TH); Pornchai Lalitnuntikul, Samutprakarn (TH)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/870,243

(22) Filed: Jun. 17, 2004

(30) Foreign Application Priority Data
Dec. 31, 2003 (TW) 092137771

(51) Int. Cl. H02J 7/00

(52) U.S. Cl. 320/125

(57) ABSTRACT

A charging apparatus is used to charge the electronic device, wherein the electronic device can generate a control signal to switch the conducting paths within the charging apparatus. The charging apparatus includes an input terminal for receiving a first type of electric power, an output terminal for coupling to the electronic device, a transducer for converting the first type of electric power into a second type of electric power, an energy storage element for storing the second type of electric power and/or providing the second type of electric power stored therein, and a relay circuit electrically connected to the transducer, the energy storage element and the output terminal, and is configured to materialize a first conducting path to charge the electronic device by the electric power from the transducer, or materialize a second conducting path to charge the electronic device by the electric power stored in the energy storage element.

### FIELD OF THE INVENTION

The present invention is related to a charging apparatus, and more particularly to a charging apparatus for use with an electronic apparatus.

### BACKGROUND OF THE INVENTION

With the incessant progress of the wireless communication technology, a mobile phone has been widely used by people as a necessary communication tool in daily life. The advent of mobile phone greatly facilitates the interactions between modern people. People can use a mobile phone to exchange information and transmit messages. Moreover, people can use a mobile phone to connect to the Internet, browse the web pages on the Internet, send/receive e-mail, and upload/download data or files.

In addition, traditional complicated circuit design has been successfully incorporated into a mobile IC component because of the advancement of IC manufacturing technique. Thus the size of a mobile phone has been scaled down as thin and small, and the portability of a mobile phone has been significantly improved. Although the high portability of a mobile phone can accommodate plenty of conveniences, a mobile phone has to count on an internal battery to supply sufficient electric power to sustain its operation. Therefore, a charging apparatus adapted to charge a mobile phone when the battery of the mobile phone is low has been put in a significant position.

FIG. 1 shows a mobile phone being connected to a charging apparatus according to the prior art. As shown in FIG. 1, if it is desired to charge the mobile phone, a charging apparatus 11 and an AC power source 10 have to be connected together, so that the mobile phone 12 is charged by the AC power source 10 through the contact with the charger 11. When the charger 11 is plugged into an outlet, it will receive an input AC power therefrom. The received AC power will be converted into a DC voltage of 5.6 volts by an AC/DC converter embedded within the charger 11 (not shown), so that the mobile phone 12 can be charged with advantage.

The conventional charging apparatus can actually perform a fast charging operation to a mobile phone. However, if the battery capacity of a mobile phone is low and there is no available external power source, the charging apparatus cannot bring itself into play to charge the mobile phone. Therefore, how to obviate the problem encountered by the prior art charging apparatus, that is, how to enable the charging apparatus to charge the mobile phone in the absence of an available external power source, has become a major task to be pursued by the invention.

### SUMMARY OF THE INVENTION

A major object of the present invention is to provide a charging apparatus that can obviate the disadvantages encountered by the prior art that the charging apparatus cannot charge an electronic device in the absence of an available external power source.

To this end, a broader aspect to be encompassed by a preferred embodiment of the present invention is directed to a charging apparatus for charging an electronic device electrically connected therewith, wherein the electronic device can generate a control signal to switch the conducting paths within the charging apparatus for charging the electronic device therethrough. The charging apparatus includes: an input terminal for receiving a first type of electric power; an output terminal for coupling to the electronic device; a transducer electrically connected to the input terminal for converting the first type of electric power into a second type of electric power; an energy storage element electrically connected between the transducer and the output terminal for storing the second type of electric power and/or providing the stored second type of electric power for the output terminal to charge the electronic device; and a relay circuit electrically connected to the transducer, the energy storage element and the output terminal, wherein the relay circuit is configured to provide either a first conducting path connected to the output terminal or a second conducting path connected to the energy storage element. The relay circuit can materialize the first conducting path and lead the power required to charge the electronic device through the first conducting path in response to the control signal. In this manner, when the input terminal receives a first type of electric power, the transducer can convert the first type of electric power into a second type of electric power, which is to be transferred to the output terminal through the first conducting path to charge the electronic device. Otherwise, when the input terminal does not receive a first type of electric power, the energy which is conserved in the form of a second type of electric power in the energy storage element is transferred to the output terminal through the second conducting path to charge the electronic device.

In accordance with the present invention, the electronic device is a portable electronic device, for example, a mobile phone, a digital audio recorder, or a personal digital assistant.

In accordance with the present invention, the transducer is an AC/DC converter.

In accordance with the present invention, the first type of electric power is an AC power, and the second type of electric power is a DC power.

In accordance with the present invention, the energy storage element includes a rechargeable battery which is electrically connected to the relay circuit and is used to store the second type of electric power, and a boost circuit which is electrically connected to the rechargeable battery and the output terminal and is used to step up the voltage level of the second type of electric power to a level being sufficient to drive the electronic device.

In accordance with the present invention, the energy storage element further includes a battery indicator which is electrically connected to the rechargeable battery for indicating the remaining capacity of the rechargeable battery.

Another broader aspect to be encompassed by a preferred embodiment of the present invention is made by the provision of a charging apparatus for charging an electronic device connected therewith, wherein the electronic device can generate a control signal to switch the conducting paths within the charging device for charging the electronic device therethrough. The charging apparatus includes: an input terminal for receiving a first type of electric power; an output terminal for coupling to the electronic device; a transducer electrically connected to the input terminal for converting the first type of electric power into a second type of electric power; an energy storage element electrically connected between the transducer and the output terminal for storing the second type of electric power; and a relay circuit electrically connected to the transducer, the energy storage element, and the output terminal, wherein the relay circuit is configured to provide either a first conducting path being connected to the output terminal or a second conducting path being connected to the energy storage element, and is able to materialize the first conducting path in response to the control signal and materialize the second conducting path in the absence of the control signal. In this way, the second type of electric power produced by the transducer can be leaded to the output terminal to charge the electronic device through the first conducting path, or can be leaded to charge the energy storage element through the second conducting path.

Now the foregoing and other features and advantages of the present invention will be best understood through the following descriptions with reference to the accompanying drawings, wherein:

### BRIEF DESCRIPTION OF THE DRAWINGS

FIG. 1 is a plan view showing a prior art charging apparatus being connected to a mobile phone;

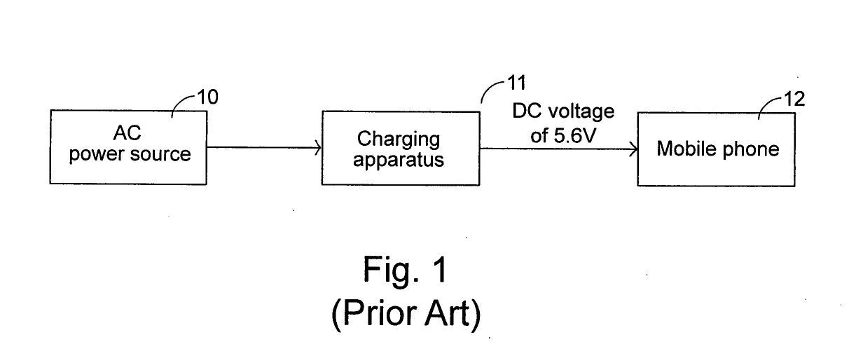

FIG. 2 is a plan view showing a charging apparatus being connected to an electronic device according to a preferred embodiment of the present invention;

FIG. 3 is a plan view showing a charging apparatus being configured to charge the electronic device according to a preferred embodiment of the present invention; and

FIG. 4 is plan view showing a charging apparatus being configured to charge the internal energy storage element according to a preferred embodiment of the present invention.

### DETAILED DESCRIPTION OF THE PREFERRED EMBODIMENT

The present invention provides a charging apparatus which utilizes a relay circuit to switch the power source of the charging apparatus either from an AC power source or from an internal rechargeable battery, and thereby eliminate the drawbacks encountered by the prior art that the charging apparatus is inoperable to charge the mobile phone in the absence of an available external power source.

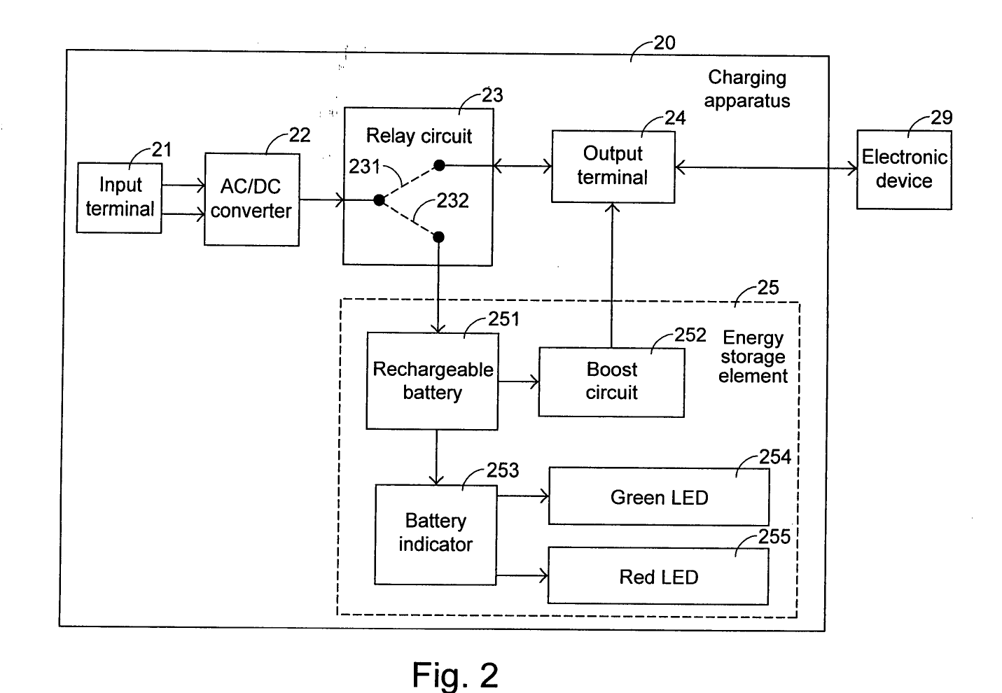

FIG. 2 shows a circuit block diagram of an electronic device being connected to a charging apparatus according to a preferred embodiment of the present invention. As shown in FIG. 2, the main function of the charging apparatus 20 is to charge the electronic device 29 with electricity. When the electronic device 29 is electrically connected to the charging apparatus 20, a control signal will be generated within the charging apparatus 20. The charging apparatus 20 basically includes an input terminal 21, an output terminal 24, a transducer, a relay circuit 23, and an energy storage element 25.

The input terminal 21 is used to receive a first type of electric power transmitted from an outlet, and the output terminal 24 is used to couple to the electronic device 29. The transducer is preferably implemented by an AC/DC converter 22, and is used to convert the first type of electric power into a second type of electric power. In the present embodiment, the first type of electric power is directed to an AC power, and the second type of electric power is directed to a DC power.

The core components of the energy storage element 25 include a rechargeable battery 251, a boost circuit 252, and a battery indicator 253. The rechargeable battery 251 is used to store the DC power outputted from the AC/DC converter 22, or discharge the DC power stored therein to the boost circuit 252 when the input terminal 21 does not receive an AC power. The boost circuit 252 can step up the voltage level of the DC power obtained from the rechargeable battery 251 to a level tailored to drive the electronic device 29, and then output the boosted DC power to the output terminal 24 to charge the electronic device 29. In addition, the battery indicator 253 is provided and electrically connected to the rechargeable battery 251, a green LED 254 and a red LED 255, and is used to monitor the remaining capacity of the rechargeable battery 251. If the battery capacity of the rechargeable battery 251 is full, the message indicating the full battery capacity condition will be given by the green LED 254. Otherwise, the red LED 255 will send an alarm message to indicate that the battery capacity of the rechargeable battery 251 is low.

The relay circuit 23 is configured to provide either a first conducting path 231 connected to the input terminal 24 or a second conducting path 232 connected to the rechargeable battery 251, and is electrically connected to the AC/DC converter 22, the rechargeable battery 251 and the output terminal 24. The main purpose of the relay circuit 23 is to materialize the first conducting path 231 in response to the control signal. When the input terminal 21 receives an input AC power, the relay circuit 23 materializes the first conducting path 231 and charges the electronic device 29 by leading the DC power produced by the AC/DC converter 22 through the first conducting path 231 to the output terminal 24. In the absence of the control signal, the relay circuit 23 materializes the second conducting path 232 and charges the rechargeable battery 251 through the second conducting path 232 when the input terminal 21 receives an input AC power.

In the present embodiment, the operation of the charging apparatus can be accomplished in compliance with the following modes:

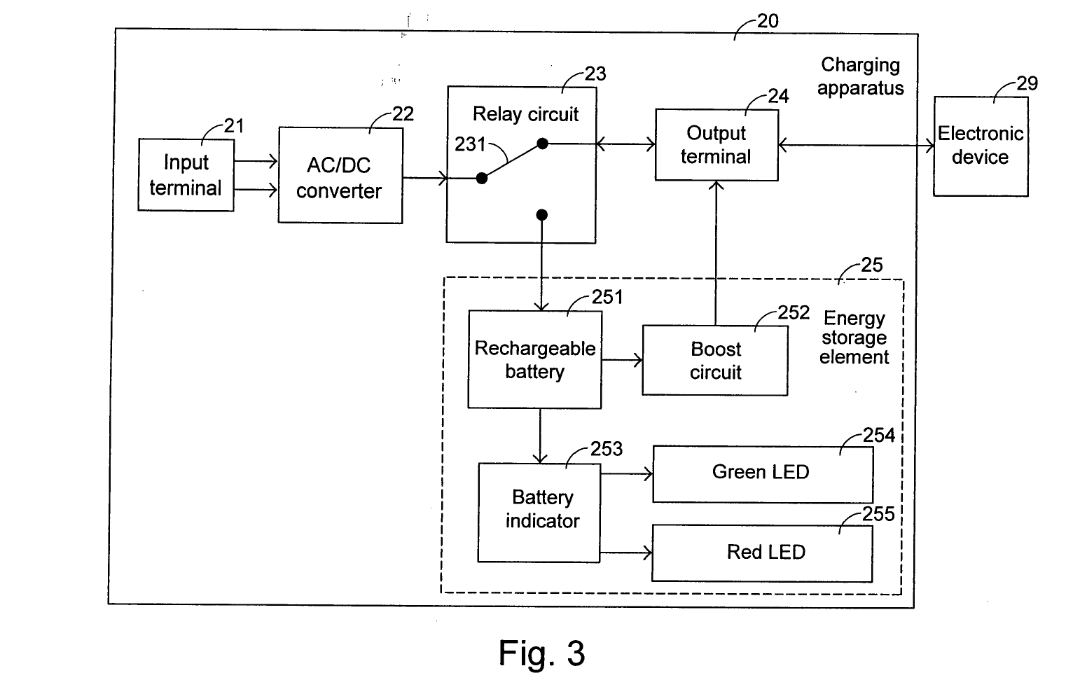

1. Referring to FIG. 3, a plan view illustrating the configuration for charging the electronic device by a charging apparatus according to the present invention is indicated. When the charging apparatus 20 is electrically connected with the electronic device 29 and an input AC power is received by the input terminal 21, as shown in FIG. 3, the relay circuit 23 materializes a first conducting path 231 in response to the control signal generated by the electronic device 29. Therefore, the input AC power is converted into a DC power by the AC/DC converter 22, and then the converted DC power is transferred to the output terminal 24 through the first conducting path 231 to charge the electronic device 29.

2. Referring to FIG. 3 again, when the charging apparatus 20 is electrically connected with the electronic device 29 but the input terminal 21 is not coupled to an input AC power, as shown in FIG. 3, the DC power stored in the rechargeable battery 251 is transferred to the boost circuit 252, and the boost circuit 252 starts stepping up the voltage level of the DC power until the voltage level of the DC power is up to a level being sufficient to drive the electronic device 29. The boosted DC power outputted from the boost circuit 252 is then transferred to the output terminal 24 to charge the electronic device 29.

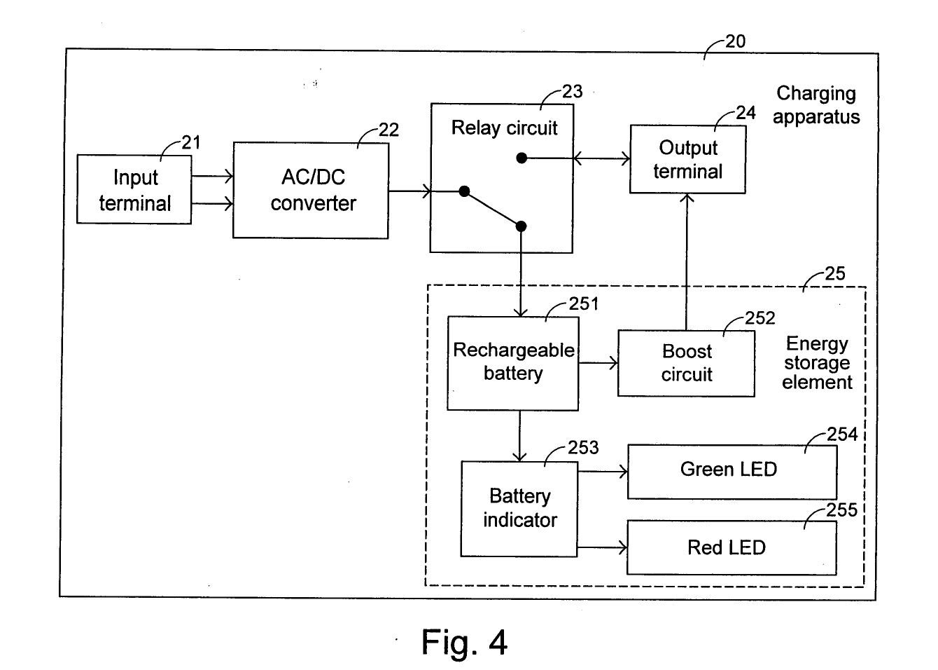

3. Referring to FIG. 4, a plan view illustrating the configuration for charging the internal energy storage element of a charging apparatus according to the present invention is indicated. As shown in FIG. 4, when the charging apparatus 20 is not coupled to the electronic device 29 and the input terminal 21 is coupled to an input AC power, the relay circuit 23 materializes a second conducting path 232 in the absence of the control signal. Therefore, the AC power is converted into a DC power by the AC/DC converter 22, and then the rechargeable battery 251 is charged by the converted DC power through the second conducting path 232.

4. Referring to FIG. 4 again, when the charging apparatus 20 is not coupled to the electronic device 20 and the input terminal 21 is not coupled to an input AC power, the charging device 20 will be working in an idle state.

In the present embodiment, the electronic device 29 is selected as a type of portable electronic device, which includes but is not limited to, a mobile phone, a digital audio recorder, and a personal digital assistant.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

1. A charging apparatus electrically connected to an electronic device for charging the electronic device, wherein the electronic device is enabled to generate a control signal to switch conduction paths within the charging apparatus, the charging apparatus comprising:
an input terminal for receiving a first type of electric power;
an output terminal for coupling to the electronic device;
a transducer electrically connected to the input terminal for converting the first type of power into a second type of electric power;
an energy storage element electrically connected to the transducer and the output terminal, wherein the energy storage element is used to store the second type of electric power or providing the output terminal with the second type of electric power stored therein to charge the electronic device; and
a relay circuit electrically connected to the transducer, the energy storage device and the output terminal, wherein the relay circuit is configured to provide either a first conducting path connected to the output terminal or a second conducting path connected to the energy storage device, and is enabled to materialize the first conducting path in response to the control signal;
wherein when the input terminal receives the first type of electric power, the second type of electric power produced by the transducer is transferred through the first conducting path to the output terminal to charge the electronic device, and when the input terminal fails to receive the first type of electric power, the second type of electric power stored in the energy storage element is transferred through the second conducting path to the output terminal to charge the electronic device.

2. The charging apparatus according to claim 1 wherein the electronic device is a portable electronic device.

3. The charging apparatus according to claim 2 wherein the portable electronic device is a mobile phone, a digital audio recorder, or a personal digital assistant.

4. The charging apparatus according to claim 1 wherein the transducer is an AC/DC converter.

5. The charging apparatus according to claim 1 wherein first type of electric power is AC power.

6. The charging apparatus according to claim 1 wherein first type of electric power is DC power.

7. The charging apparatus according to claim 1 wherein the energy storage element comprises:
a rechargeable battery electrically connected to the relay circuit for storing the second type of electric power; and
a boost circuit electrically connected to the rechargeable battery and the output terminal for stepping up a voltage level of the second type of electric power to a level being sufficient to drive the electronic device.

8. The charging apparatus according to claim 7 wherein the energy storage element further includes a battery indicator electrically connected to the rechargeable battery for indicating a remaining capacity of the rechargeable battery.

9. A charging apparatus electrically connected to an electronic device for charging the electric device, wherein the electronic device is enabled to generate a control signal to switch the conducting paths within the charging apparatus, the charging apparatus comprising:
an input terminal for receiving a first type of electric power;
an output terminal for coupling to the electronic device;
a transducer electrically connected to the input terminal for converting the first type of electric power into a second type of electric power;
an energy storage element electrically connected between the transducer and the output terminal for storing the second type of electric power; and
a relay circuit electrically connected to the transducer, the energy storage element and the output terminal, and is configured to provide either a first conducting path connected to the output terminal or a second conducting path connected to the energy storage element, wherein the relay circuit is enabled to materialize the first conducting path in response to the control signal and materialize the second conducting path in the absence of the control signal;
wherein when the input terminal receives the first type of electric power, the second type of electric power produced by the transducer is transferred through the first conducting path to the output terminal to charge the electronic device, otherwise the second type of electric power produced by the transducer is transferred through the second conducting path to charge the energy storage element.

10. The charging apparatus according to claim 9 wherein the electronic device is a mobile phone.

11. The charging apparatus according to claim 9 wherein the transducer is an AC/DC converter.

12. The charging apparatus according to claim 9 wherein the first type of electric power is AC power.

13. The charging apparatus according to claim 9 wherein the second type of electric power is DC power.

14. The charging apparatus according to claim 9 wherein the energy storage element comprises:
a battery electrically connected to the relay circuit for storing the second type of electric power; and
a boost circuit electrically connected to the battery and the output terminal for stepping up a voltage level of the second type of electric power to a level being sufficient to drive the electronic device.

15. The charging apparatus according to claim 14 wherein the energy storage element includes a battery indicator electrically connected to the battery for indicating a remaining capacity of the battery.

16. The charging apparatus according to claim 14 wherein the battery is a rechargeable battery.
